(19) United States
(12) Patent Application Publication
(10) Pub. No.: US 2008/0068703 A1
(43) Pub. Date: Mar. 20, 2008

(54) Glass Composition Containing Bismuth and Method of Amplifying Signal Light Therewith

(75) Inventors: Masahiro Nakatsuka, Osaka (JP); Yasushi Fujimoto, Osaka (JP); Young-Seok Seo, Osaka (JP); Koichi Sakaguchi, Tokyo (JP); Shoichi Kishimoto, Tokyo (JP)

Correspondence Address: HAMRE, SCHUMANN, MUELLER & LARSON, P.C., P.O. BOX 2902, MINNEAPOLIS, MN, 55402-0902, US

(73) Assignee: JAPAN SCIENCE AND TECHNOLOGY AGENCY, SAITAMA (JP)

(21) Appl. No.: 11/885,066

(22) PCT Filed: Feb. 23, 2006
(86) PCT No.: PCT/JP06/03322

§ 371 Date: Nov. 21, 2007

(30) Foreign Application Priority Data
Feb. 25, 2005 (JP) 2005-050540

(51) Int. Cl. H04B 10/12; C03C 3/06; C03C 3/083; G02B 6/00

(52) U.S. Cl. 359/341.5; 385/142; 501/54; 501/63

(57) ABSTRACT

The present invention provides a novel glass composition in which fluorescence derived from bismuth (Bi) is obtained and whose meltability is improved. The glass composition of the present invention includes bismuth oxide, Al₂O₃ and SiO₂. SiO₂ is a main component of glass network forming oxide included in the glass composition. The glass composition further includes at least one oxide selected from TiO₂, GeO₂, P₂O₅ and B₂O₃. A total content of SiO₂, the at least one oxide, Y₂O₃ and lanthanide oxide is over 80 mol %. Bismuth included in the bismuth oxide functions as a luminous species. Upon irradiation of excitation light, the glass composition emits fluorescence in the infrared wavelength range.

### TECHNICAL FIELD

The present invention relates to a glass composition that contains Bi as a luminous species and that can function as a light emitter or an optical amplification medium.

### BACKGROUND ART

Glass compositions are known that contain a rare earth element such as Nd, Er or Pr and emit fluorescence in the infrared region. This fluorescence is derived from an emission transition of 4f electrons in rare earth ions. However, since the 4f electrons are shielded by outer shell electrons, the wavelength range in which fluorescence can be obtained is narrow. Accordingly, the wavelength range in which light can be amplified or laser oscillation can be obtained is limited.

JP2002-252397 A discloses quartz glass based optical fibers that are doped with Bi and contain Al₂O₃. From these optical fibers, fluorescence is obtained, which is derived from Bi in a wide wavelength range. Such optical fibers also serve as optical amplifiers having excellent compatibility with quartz glass optical fibers. However, in order to obtain the optical fibers disclosed in JP2002-252397 A, the raw materials have to be melted at a temperature as high as about 1750° C. and the yielding point reaches at 1000° C. or higher. Thus, a complicated apparatus is required for fabricating the optical fibers, and it is not easy to fabricate the optical fibers with excellent homogeneity.

JP2003-283028 A discloses glass compositions including a divalent metal oxide as well as Bi₂O₃, Al₂O₃ and SiO₂. Divalent metal oxides improve the meltability of glass and enhance the homogeneity of glass. The Examples in JP2003-283028 A disclose glass compositions having Bi as a luminous species, including a monovalent metal oxide as well as a divalent metal oxide and obtained by melting at a temperature of 1600° C.

### DISCLOSURE OF INVENTION

Although divalent metal oxides and monovalent metal oxides improve the meltability of Bi₂O₃—Al₂O₃—SiO₂ glass, attempting to lower melting temperature relying on adding these oxides decreases the emission intensity from Bi. Therefore, an object of the present invention is to provide a novel glass composition in which fluorescence derived from Bi is obtained and whose meltability is improved.

The present invention provides a glass composition including bismuth oxide, Al₂O₃ and SiO₂. SiO₂ is a main component of glass network forming oxide included in the glass composition. The glass composition further includes at least one oxide selected from TiO₂, GeO₂, P₂O₅ and B₂O₃. A total content of SiO₂, the above-mentioned at least one oxide, Y₂O₃ and lanthanide oxide is over 80 mol %. Bismuth included in the bismuth oxide functions as a luminous species. Upon irradiation of excitation light, the glass composition emits fluorescence in the infrared wavelength range. In the present description, a main component is defined as a component that is included in the largest amount.

Although TiO₂, GeO₂, P₂O₅ and B₂O₃ are components improving glass meltability similar to the divalent metal oxides and monovalent metal oxides, these components do not have much influence on lowering the emission intensity from Bi, different from the divalent metal oxides and monovalent metal oxides. On the contrary, the components may even increase the emission intensity. In the glass composition of the present invention, the total content of SiO₂, TiO₂, GeO₂, P₂O₅, B₂O₃, Y₂O₃ and the lanthanide oxide is adjusted to be over 80 mol % in order to obtain easily the fluorescence derived from Bi.

In this way, according to the present invention, a glass composition in which fluorescence derived from Bi and whose meltability is improved is provided. When the meltability of glass composition is improved, the composition easily can be made into a fiber. On fabrication of an optical fiber having a clad core glass, a lower melting point of the core glass enables simple manufacturing facilities and easy temperature control during manufacture.

### BRIEF DESCRIPTION OF DRAWINGS

FIG. 1 is a structure diagram that shows an example of the optical amplification apparatus of the present invention.

FIG. 2 is a chart that shows a relationship between x and emission intensity from Bi in a 1Bi₂O₃-7Al₂O₃-xLi₂O-(92-x)SiO₂ glass.

FIG. 3 is a diagram that shows a structure of an apparatus used for measuring gain coefficients in the Example.

FIG. 4 shows a transmission spectrum of the glass sample 81.

FIG. 5 shows an absorption coefficient spectrum of the glass sample 81.

FIG. 6 shows a fluorescence spectrum obtained by radiating excitation light having a wavelength of 500 nm to the glass sample 81, where λ_{P} denotes peak-fluorescence wavelength, λ_{CX} denotes excitation wavelength and Δ_{X} denotes full width at half maximum (FWHM).

FIG. 7 shows a fluorescence spectrum obtained by radiating excitation light having a wavelength of 700 nm to the glass sample 81, where λ_{P}, λ_{CX} and Δλ denote the same as above.

FIG. 8 shows a fluorescence spectrum obtained by radiating excitation light having a wavelength of 800 nm to the glass sample 81, where λ_{P}, λ_{CX} and Δλ denote the same as above.

FIG. 9 is a chart that shows wavelength dependency of refractive indexes of silica glass, conventional glass (the glass samples 100a and 100b) and the glass sample 101 according to the present invention.

### BEST MODE FOR CARRYING OUT THE INVENTION

In the description below, “%” that indicates a content of each component is defined as mol%.

The glass composition of the present invention includes at least one oxide selected from TiO₂, GeO₂, P₂O₅ and B₂O₃ as well as SiO₂ as a main component as glass network forming oxide, bismuth oxide and Al₂O₃. In contrast to these, the components other than above, such as Y₂O₃ and lanthanide oxide, are components that either may be contained or not contained (optional components).

Although the valence number of bismuth in the glass composition is not yet clearly defined, one promising possibility is trivalent (Bi₂O₃) and/or pentavalent (Bi₂O₅) according to studies by the present inventors. A content of the bismuth oxide in terms of Bi₂O₃ is preferably from 0.01% to 15%, further preferably from 0.01% to 5% and particularly preferably from 0.01% to 1%. The content also may be from 0.01% to 0.5%.

Examples of the glass network forming oxide include SiO₂, GeO₂, P₂O₅, B₂O₃ and V₂O₅. Although the glass network forming oxide in the glass composition of the present invention may be one or a plurality of types, the main component of the glass network forming oxide is SiO₂. A preferable content of SiO₂ is from 75% to 98.5%.

Since Al₂O₃ has a somewhat low ability as a glass network former compared to the examples of the glass network forming oxide listed above, Al₂O₃ is not defined as glass network forming oxide in the present description. Al₂O₃ is a component necessary for Bi to exhibit fluorescence in the glass composition. A preferable content of Al₂O₃ is from 0.5% to 25%.

TiO₂, GeO₂, P₂O₅ and B₂O₃ play a role in improving glass meltability, and TiO₂ and GeO₂ even can function to enhance the emission intensity from Bi. The glass composition of the present invention includes at least one oxide selected from TiO₂, GeO₂, P₂O₅ and B₂O₃, and the at least one oxide preferably include TiO₂ and/or GeO₂, and it further preferably includes GeO₂. The glass composition of the present invention also may include both TiO₂ and GeO₂. Although a content of TiO₂ and/or GeO₂ is preferably 0.1% or more, further preferably 1% or more and particularly preferably 5% or more for enhancing the emission intensity, a content of TiO₂ should be below 10%. This is because the glass composition might be opalized when TiO₂ is added excessively.

Although the reason for the enhancement in the emission intensity from Bi by addition of TiO₂ and/or GeO₂ is not yet clearly defined, one possibility is that the emission intensity is enhanced due to the rutile structure these oxides may have. According to analysis of the coordination geometry of Bi and Al, the fluorescence from Bi is considered to be derived from the proximity placement of Bi and Al in the rutile structure formed partially in the glass. Adding an oxide with rutile structure may include a probability for establishing a characteristic coexistence of Bi and Al in which Bi and Al are incorporated into the rutile structure to have Bi emit fluorescence. As a result, the emission intensity is considered to be enhanced.

The enhancement of the emission intensity by adding TiO₂ and/or GeO₂ becomes outstanding when the content of the bismuth oxide in terms of Bi₂O₃ is 1% or less, particularly when 0.5% or less. The enhancing effect in a glass composition having a low bismuth oxide content becomes outstanding by adding GeO₂. In the glass composition according to the present invention, the at least one oxide preferably includes GeO₂ when the content of bismuth oxide in terms of Bi₂O₃ is from 0.01% to 0.5%.

In the glass composition of the present invention, the total content of TiO₂, GeO₂, P₂O₅ and B₂O₃ is preferably 1% or more, particularly 5% or more, and is more preferably more than the total content of monovalent metal oxide and divalent metal oxide. As the monovalent metal, Group I metals, specifically Li, Na and K, should be considered, and as the divalent metal, specifically Mg, Ca, Sr and Ba of Group II metal and Zn should be considered.

Excessive amounts of monovalent metal oxide and divalent metal oxide lower the emission intensity from Bi. The monovalent metal decreases the emission intensity more than the divalent metal does, and Mg has the largest decreasing effect among the divalent metals. In the glass composition of the present invention, the total content of monovalent metal oxide and divalent metal oxide is preferably below 10%, further preferably below 8% and particularly preferably below 5%.

One of the characteristics of the glass composition of the present invention is that the total content of SiO₂, TiO₂, GeO₂, P₂O₅, B₂O₃, Y₂O₃ and lanthanide oxide is over 80%. This total content may be over 85% and further may be 90% or more. In the glass composition of the present invention, the content of the glass network forming oxide may be over 80% and preferably may be over 85%.

Although the lanthanide oxide is not particularly limited, lanthanide elements other than Pr, Nd, Dy, Ho, Er, Tm and Yb (La, Ce, Pm, Sm, Eu, Gd, Tb and Lu) are favorable, and La and Lu are particularly favorable.

The glass composition of the present invention preferably further includes at least one selected from Y₂O₃, La₂O₃ and Lu₂O₃, particularly Y₂O₃. This is because the optical distortion of the glass can be reduced when Y₂O₃, La₂O₃ and Lu₂O₃ are added. Although the total content of Y₂O₃, La₂O₃ and Lu₂O₃ is not particularly limited, it may be from 0.1% to 5%, for example.

A preferable composition for the glass composition of the present invention is listed below as an example. The numeric values in the parentheses show more preferable contents.

SiO₂: from 75% to 98.5% (from 75% to 98%, further preferably from 80% to 95%, particularly preferably from 80% to 92%), Al₂O₃: from 0.5% to 25% (from 1.5% to 25%, particularly preferably from 5% to 25%), Li₂O: 0% or more and below 10% (from 0% to 5%), Na₂O: from 0% to 5%, K₂O: from 0% to 5%, MgO: 0% or more and below 10% (from 0% to 5%), CaO: 0% or more and below 10% (from 0% to 5%), SrO: from 0% to 5%, BaO: from 0% to 5%, ZnO: from 0% to 5%, TiO₂: 0% or more and below 10% (from 0% to 8%), GeO₂: from 0% to 20% (from 0% to 10%), P₂O₅: from 0% to 10% (from 0% to 5%), B₂O₃: from 0% to 10% (from 0% to 5%), ZrO₂: from 0% to 5%, Y₂O₃: from 0% to 5%, lanthanide oxide: from 0% to 5%, bismuth oxide in terms of Bi₂O₃: 0.01% to 15% (from 0.01% to 5%, further preferably 0.01% to 1%).

In the above composition, the sum of content indicated by TiO₂+GeO₂+P₂O₅+B₂O₃ is preferably 1% or more, further preferably 3% or more and particularly preferably 5% or more, and is more preferably larger than the sum of content indicated by MgO+CaO+SrO+BaO+ZnO+Li₂O+Na₂O+K₂O. In addition, the sum of content indicated by MgO+CaO+SrO+BaO+ZnO+Li₂O+Na₂O+K₂O is more preferably below 10%, further preferably below 8% and particularly preferably below 5%. Still in addition, the sum of content indicated by SiO₂+TiO₂+GeO₂+P₂O₅+B₂O₃+Y₂O₃+lanthanide oxide may be over 80% and further may be over 85%.

The glass composition of the present invention substantially may consist essentially of the components listed above. However, even in this case, the glass composition of the present invention may further include Ta₂O₅, Ga₂O₃, Nb₂O₅ and In₂O₃, preferably up to 5% in total, other than the components above depending on various purposes typically as controlling the refractive index. In addition, it may include As₂O₃, Sb₂O₃, SO₃, SnO₂, Fe₂O₃, Cl and F, preferably up to 3% in total, for the purposes such as refinement while melting and prevention of bismuth reduction. As a trace amount of impurities, components other than above sometimes mix with the raw materials for glass. However, when the total content of these impurities is below 1%, the influence over the physical properties of the glass composition is small and they substantially make no problem.

The glass composition of the present invention can be used as an optical amplification medium. An optical fiber including the glass composition of the present invention (such as a core/cladding type optical fiber having the core glass formed of the glass composition of the present invention) is suitable for amplifying signal light.

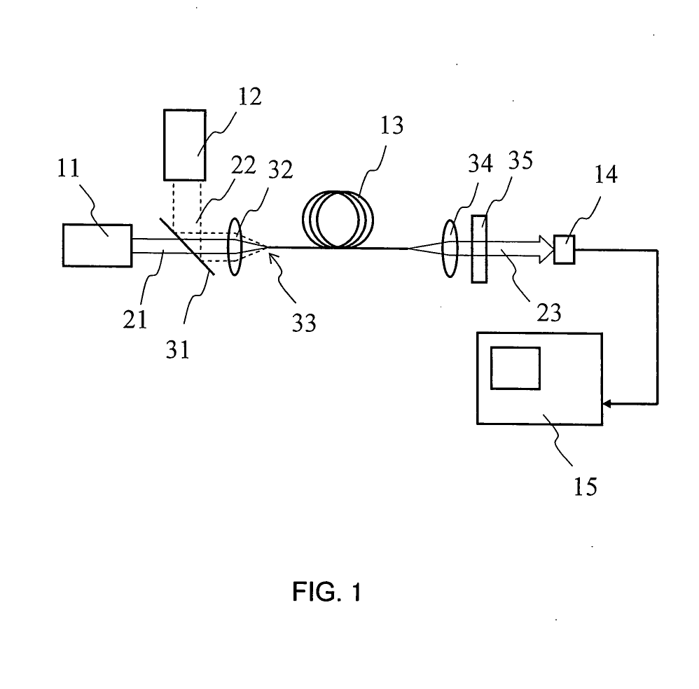

FIG. 1 shows an example of the optical amplification apparatus including the glass composition of the present invention, and an example of the method of amplifying signal light using the same is illustrated.

A wavelength of an excitation light 22 to be a power source for optical amplification may be, for example, 808 nm, and a wavelength of a signal light 21 to be amplified may be, for example, 1314 nm. In this apparatus, the excitation light 22 and the signal light 21 are collected by a lens 32, and they are superimposed spatially near an optical fiber end 33, which is an entrance to the core of an optical fiber 13. The excitation light 22 and the signal light 21 are kept to be superimposed in the core of the optical fiber 13. Thus, the signal light 21 transmitted from the optical fiber 13 is amplified.

Light sources 12 and 11 for the excitation light 22 of a wavelength of 808 nm and the signal light 21 of a wavelength of 1314 nm may use continuum from a semiconductor laser. The signal light and the excitation light are multiplexed using a wavelength selection reflecting mirror 31 that passes the signal light 21 and reflects the excitation light 22. A light 23 emitted from the optical fiber 13 is guided to a photodetector 14 by a lens 34. A filter 35 for transmitting the signal light and blocking the excitation light is inserted into the optical path, and the photodetector 14 detects the signal light only. The degree of amplification of the detected signal light can be observed using an oscilloscope 15.

The optical amplification apparatus is not limited to the structure shown in the figure. For example, an optical fiber for signal input instead of the light source for the signal light and an optical fiber for signal output instead of the photodetector may be disposed respectively, and the excitation light and the signal light may be multiplexed and demultiplexed using a fiber coupler.

Although the structure of FIG. 1 is only an example, such an optical amplification apparatus enables carrying out the method of amplifying signal light. The method introduces excitation light and signal light into the glass composition of the present invention and amplifies the signal light. A wavelength range of the excitation light may be from 400 nm to 900 nm, such as from 500 nm to 600 nm or from 760 nm to 860 nm, and a wavelength range of the signal light may be from 1000 nm to 1600 nm, such as from 1050 nm to 1350 nm and from 1500 nm to 1600 nm.

Hereinbelow, the present invention is described further in detail by Examples.

### Preliminary Experiment

This experiment was intended to check the reduction effect in the emission intensity from Bi due to Li₂O, which is monovalent metal oxide. In order to prepare the compositions shown in Table 1, silicon oxide, aluminum oxide, bismuth oxide (Bi₂O₃) and lithium carbonate were weighed and each batch was mixed well in a mortar. The batches thus obtained were introduced into alumina crucibles and melted in an electric furnace kept at a temperature of 1750° C. for 30 hours. After that, they were annealed at a rate of 150° C. per hour down to a temperature of 1000° C., and then the furnace was turned off to leave them cooling down to room temperature.

TABLE 1
(mol %)

| Sample | Bi₂O₃ | Al₂O₃ | SiO₂ | Li₂O |
|---|---|---|---|---|
| A | 1 | 7 | 92 | 0 |
| B | 1 | 7 | 91 | 1 |
| C | 1 | 7 | 87 | 5 |
| D | 1 | 7 | 82 | 10 |

Glass samples A to D thus obtained were cut and polished to a mirror finish on their surfaces until making each of them into a flat plate with a thickness of 3 mm. Thus, measurement samples were fabricated. Using a commercially available spectrofluorometer, the fluorescence spectrum of a measurement sample obtained from each glass sample was measured. The measurement was carried out with excitation light having a wavelength of 800 nm and with the samples kept at room temperature. Every glass sample exhibited a fluorescence peak in a range of wavelengths from 1000 nm to 1600 nm, i.e., in the infrared wavelength range.

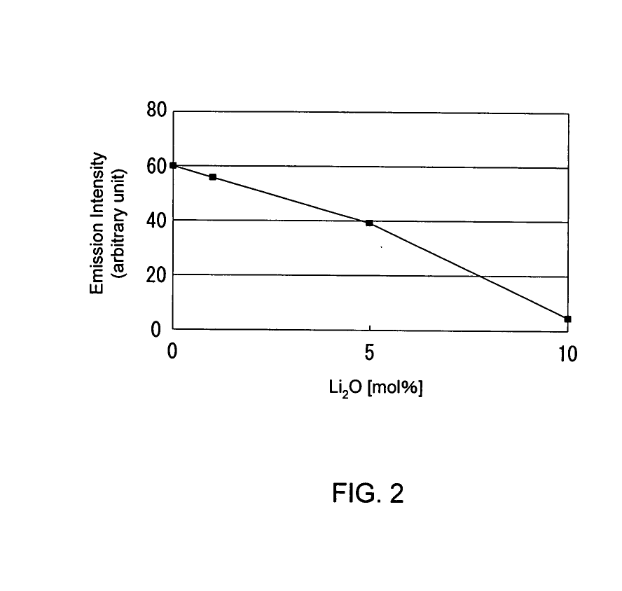

FIG. 2 shows a relationship between the intensity of emission peak (emission intensity) exhibited in the fluorescence spectrum from each glass sample and the Li₂O content in each glass sample. As shown in FIG. 2, the fluorescence intensity was considerably lowered as the Li₂O content increased.

According to experiments similar to above, monovalent metal such as Na₂O and divalent metal such as MgO were confirmed, like Li₂O, to function to lower the emission intensity from Bi.

### EXAMPLE 1

In order to prepare the compositions shown in Table 2, silicon oxide, aluminum oxide, bismuth oxide (Bi₂O₃), yttrium oxide, germanium oxide, titanium oxide, boron oxide, diphosphorus pentoxide (P₂O₅) and lithium carbonate were weighed and each batch was mixed well in a mortar. The glass batches thus obtained were charged into quartz glass tubes of an inner diameter of 2 mm, and these glass tubes were heated by an infrared heater and then annealed to obtain glass samples 1 to 24. All of the glass samples 1 to 24 were in reddish brown. This is a characteristic color for glasses in which fluorescence derived from Bi is observed in the infrared region.

With each composition shown in Table 2, the “melting point” of the glass batch (raw material melting temperature) was measured. The melting points were measured by heating the glass tubes charged with the glass batch by an infrared heater and by recording the temperature at which the batch started melting (melt starting temperature) and the temperature at which the batch completely melted (melt ending temperature). The temperatures were measured using a thermocouple attached to each quartz glass tube. The time required from the start of measurement (room temperature) to the end of measurement (complete melting of the batch) was from four to five minutes approximately.

As shown in Table 2, melting the batch of each composition was completed at temperatures of 1650° C. or below. For comparison, a batch prepared to have the composition of the glass sample A (refer to Table 1: 1Bi₂O₃-7Al₂O₃-92SiO₂) was subjected to the melting point measurement same as above, and melting this batch was not completed until the temperature had risen at 1750° C. or higher.

Subsequently, the emission intensity (fluorescence intensity) of some of the glass samples was measured in the same manner as the preliminary experiment. All the measured glass samples exhibited their fluorescence peaks in the wavelength range similar to that of the samples A to D. Table 2 shows a relative value of the emission intensity of each sample when the emission intensity of the glass sample 1 is defined as 100.

The emission intensity of some of the glass samples in which GeO₂ and TiO₂ were added became larger. The emission intensity enhancing effect due to GeO₂ and TiO₂ was sufficient to be as outstanding as cancelling the intensity reduction due to the trace amount of Li₂O.

TABLE 2
(Component: mol %)

| | | | | | Other | Batch | |
|---|---|---|---|---|---|---|---|
| | | | | | Components | Melting | |
| | | | | | (numeric values | Temperature | Emission |
| Sample | Bi₂O₃ | Al₂O₃ | SiO₂ | Y₂O₃ | in mol %) | [° C.] | Intensity |
| 1 | 1 | 7 | 90.8 | 0.2 | GeO₂(1) | 1550-1600 | 100 |
| 2 | 1 | 7 | 86.8 | 0.2 | GeO₂(5) | 1500-1550 | 128 |
| 3 | 1 | 7 | 81.8 | 0.2 | GeO₂(10) | 1500-1550 | 153 |
| 4 | 1 | 7 | 90.8 | 0.2 | TiO₂(1) | 1550-1600 | — |
| 5 | 1 | 7 | 86.8 | 0.2 | TiO₂(5) | 1500-1550 | 237 |
| 6 | 1 | 7 | 90.8 | 0.2 | B₂O₃(1) | 1600-1650 | 84 |
| 7 | 1 | 7 | 86.8 | 0.2 | B₂O₃(5) | 1600-1650 | — |
| 8 | 1 | 7 | 81.8 | 0.2 | B₂O₃(10) | 1600-1650 | — |
| 9 | 1 | 7 | 84.0 | 3 | GeO₂(5) | 1600-1650 | 91 |
| 10 | 1 | 7 | 79.0 | 3 | GeO₂(10) | 1600-1650 | — |
| 11 | 1 | 7 | 86.8 | 0.2 | GeO₂(2.5), | 1550-1600 | 158 |
| | | | | | TiO₂(2.5) | | |
| 12 | 1 | 7 | 81.8 | 0.2 | GeO₂(5), | 1450-1500 | 181 |
| | | | | | TiO₂(5) | | |
| 13 | 2 | 7 | 85.8 | 0.2 | GeO₂(5) | 1500-1550 | 299 |
| 14 | 2 | 7 | 80.8 | 0.2 | GeO₂(10) | 1450-1500 | 334 |
| 15 | 3 | 7 | 84.8 | 0.2 | GeO₂(5) | 1450-1500 | 336 |
| 16 | 3 | 7 | 79.8 | 0.2 | GeO₂(10) | 1450-1500 | 417 |
| 17 | 1.05 | 6.84 | 89.3 | 0.21 | P₂O₅(2.63) | 1550-1600 | — |
| 18 | 1.11 | 5.56 | 87.6 | 0.23 | P₂O₅(5.56) | 1550-1600 | — |
| 19 | 1 | 7 | 80.8 | 0.2 | GeO₂(10), | 1550-1600 | 141 |
| | | | | | Li₂O(1) | | |
| 20 | 1 | 7 | 80.8 | 0.2 | GeO₂(5), | 1500-1550 | 122 |
| | | | | | TiO₂(5), | | |
| | | | | | Li₂O(1) | | |
| 21 | 2 | 7 | 84.8 | 0.2 | TiO₂(5), | 1400-1450 | 228 |
| | | | | | Li₂O(1) | | |
| 22 | 2 | 7 | 84.8 | 0.2 | GeO₂(5), | 1500-1550 | 79 |
| | | | | | Li₂O(1) | | |
| 23 | 2 | 7 | 79.8 | 0.2 | GeO₂(10), | 1450-1500 | 78 |
| | | | | | Li₂O(1) | | |
| 24 | 2 | 7 | 79.8 | 0.2 | GeO₂(5), | 1450-1500 | 249 |
| | | | | | TiO₂(5), | | |
| | | | | | Li₂O(1) | | |

### EXAMPLE 2

In order to prepare the compositions shown in Table 3, glass batches were prepared using the same raw materials as the Example 1, and each glass batch was melted in the same manner as the preliminary experiment to obtain each glass sample. The emission intensity of each glass sample was measured in the same manner as above. In this Example 2, in addition to the fluorescence intensity at a wavelength of 1250 nm by excitation light having a wavelength of 800 nm, the fluorescence intensity at a wavelength of 1140 nm by excitation light having a wavelength of 500 nm was measured.

Table 3 shows the emission intensity of both types of the fluorescence mentioned above. In Table 3, the emission intensity at each Bi₂O₃ concentration is indicated by a relative value to a glass sample having the same composition other than not including GeO₂ and TiO₂ (a Bi₂O₃—Al₂O₃—Y₂O₃—SiO₂ glass) or having a similar composition that does not include GeO₂ and TiO₂ (a Bi₂O₃—Al₂O₃—SiO₂ glass).

TABLE 3
(Component: mol %)

| | | | | | | Excitation | Excitation |
|---|---|---|---|---|---|---|---|
| | | | | | | of | of |
| | | | | | | 800 nm, | 500 nm, |
| | | | | | | Fluores- | Fluores- |
| | | | | | | cence at | cence at |
| Sample | Bi₂O₃ | Al₂O₃ | Y₂O₃ | GeO₂ | TiO₂ | 1250 nm | 1140 nm |
| 30* | 1 | 7 | 0.2 | 0 | 0 | 1.0 | 1.0 |
| | | | | | | (reference) | (reference) |
| 31 | 1 | 7 | 0.2 | 5 | 0 | 1.2 | 0.9 |
| 40* | 0.5 | 7 | 0 | 0 | 0 | 1.0 | 1.0 |
| | | | | | | (reference) | (reference) |
| 41 | 0.5 | 7 | 0.2 | 5 | 0 | 1.6 | 0.9 |
| 50* | 0.3 | 7 | 0.2 | 0 | 0 | 1.0 | 1.0 |
| | | | | | | (reference) | (reference) |
| 51 | 0.3 | 7 | 0.2 | 5 | 5 | 9.3 | 1.8 |
| 52 | 0.3 | 7 | 0.2 | 1 | 1 | 3.3 | 2.5 |
| 60* | 0.1 | 0.23 | 0 | 0 | 0 | 1.0 | 1.0 |
| | | | | | | (reference) | (reference) |
| 61 | 0.1 | 7 | 0.2 | 5 | 5 | 12.5 | 1.6 |
| 62 | 0.1 | 7 | 0.2 | 3 | 3 | 8.5 | 1.8 |
| 63 | 0.1 | 7 | 0.2 | 5 | 0 | 21.5 | 2.4 |
| 64 | 0.1 | 7 | 0.2 | 3 | 0 | 14.5 | 2.4 |

*The rest of the composition of each glass sample is SiO₂.
*Glass Samples 30, 40, 50 and 60 are Comparative Examples.

As shown in Table 3, the emission intensity enhancing effect due to the addition of GeO₂ and TiO₂ was observed in the compositions having a low bismuth oxide content, not only in the fluorescence at a wavelength of 1250 nm by excitation light having a wavelength of 800 nm but also in the fluorescence at a wavelength of 1140 nm by excitation light having a wavelength of 500 nm. However, the emission intensity enhancing effect was more outstanding in the fluorescence at a wavelength of 1250 nm.

As shown in Table 3, the emission intensity enhancing effect due to GeO₂ and TiO₂ was likely to be more outstanding when the bismuth oxide content was lower. Particularly, a large enhancing effect can be obtained in a composition having a content of bismuth oxide of 0.3% or less in terms of Bi₂O₃. In a composition having a low bismuth oxide content, addition of GeO₂ is more effective. The data of glass samples 60 to 64 suggest that GeO₂ should be added alone not, i.e. with TiO₂, in a composition having a low content of bismuth oxide in terms of Bi₂O₃ (such as the content in terms of Bi₂O₃ is 0.1% or less). On the other hand, coaddition of GeO₂ and TiO₂ resulted in more favorable results in the compositions including bismuth oxide of 1% or more in terms of Bi₂O₃ (Table 2; comparison between the glass samples 2 and 12, for example).

The outstanding enhancing effect in emission intensity due to the addition of GeO₂ is significant, particularly in a composition having a low bismuth oxide content, as a compensation for the reduction in emission intensity due to the reduction in the bismuth oxide content.

### EXAMPLE 3

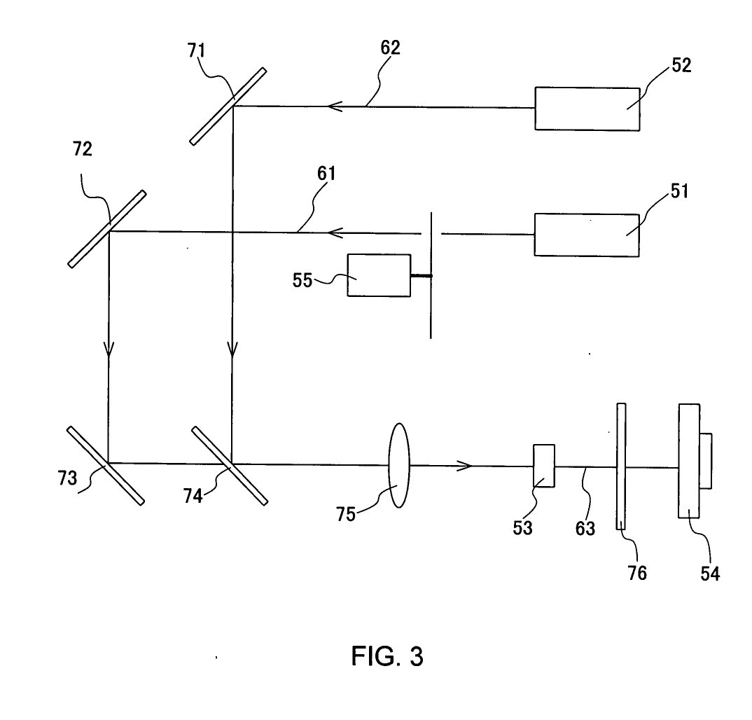

In the same manner as the Example 2, glass samples having the compositions shown in Table 4 were obtained. The emission intensity of each glass sample was measured in the same manner as above, and further the gain measurement was carried out. Results are shown in Table 4. The gain measurement was carried out using the apparatus shown in FIG. 3 in the following manner.

In the measurement system shown in FIG. 3, a signal light 61 having a wavelength of 1.3 μm is emitted from a laser diode 51 and an excitation light 62 having a wavelength of 0.8 μm is emitted from a laser diode 52. The signal light 61 is reflected by reflecting mirrors 72 and 73 and introduced to a wavelength selection reflecting mirror 74, and then passes through the reflecting mirror 74. On the other hand, the excitation light 62 is reflected by a reflecting mirror 71 and introduced to the wavelength selection reflecting mirror 74, and then is reflected by the reflecting mirror 74. The wavelength selection reflecting mirror 74 is designed to transmit light with a wavelength of 1.3 μm and to reflect light with a wavelength of 0.8 μm. In this way, the signal light 61 and the excitation light 62 are either passed through or reflected by the wavelength selection reflecting mirror 74 and travel in an almost identical optical path, and then they are collected onto a glass sample 53 by a lens 75. A light 63 that passed through the glass sample 53 passes through an infrared transmitting filter 76 and is introduced to a detector 54 to have its intensity measured. The infrared transmitting filter 76 is designed to shield light with a wavelength of 0.8 μm and to transmit light with a wavelength of 1.3 μm.

The signal light 61 is subjected to chopper control by a chopper 55 in between the laser diode 51 and the reflecting mirror 72. This control turns the light with a wavelength of 1.3 μm into a rectangular wave, and it becomes possible automatically to repeat turning the signal light 61 on/off. This enables to check for the influence of the spontaneous emission light other than the signal light 61 by referring to the off state. In the experiment below, it was confirmed that there was no influence of the spontaneous emission light.

Using the apparatus shown in FIG. 3, an optical amplification ratio, which is defined below, was measured.
Optical Amplification Ratio (%)=(C−D)/(B−A)=I/I_{O}

Here, A denotes light intensity measured when both the signal light and the excitation light are not emitted (background), B denotes light intensity measured when only the signal light is emitted, C denotes light intensity measured when both the signal light and excitation light are emitted and D denotes light intensity measured when only the excitation light is emitted. I denotes intensity of output light and I_{O} denotes intensity of incident light.

In addition, gain coefficients, which are defined below, were calculated from the optical amplification ratio obtained above.
Gain Coefficient (c⁻¹)=(1/t)ln(I/I_{O})

Here, t (cm) denotes thickness of the glass sample 53 in the direction of optical transmission.

TABLE 4
(Component: mol %)

| | | | | | Excitation of | Excitation of | | | |
|---|---|---|---|---|---|---|---|---|---|
| | | | | | 800 nm, | 500 nm, | | Amplification | Gain |
| | | | | | Fluorescence | Fluorescence | Thickness | Ratio | Coefficient |
| Sample | Bi₂O₃ | Al₂O₃ | Y₂O₃ | GeO₂ | at 1250 nm | at 1140 nm | [cm] | [%] | [cm⁻¹] |
| 80* | 1 | 7 | 0.2 | 0 | 1.0 | 1.0 | 0.435 | 129 | 0.58 |
| 81 | 0.5 | 7 | 0.2 | 5 | 1.2 | 0.9 | 0.360 | 121 | 0.54 |

*The rest of the component of each glass sample is SiO₂.
*Glass Sample 80 is a Comparative Example.

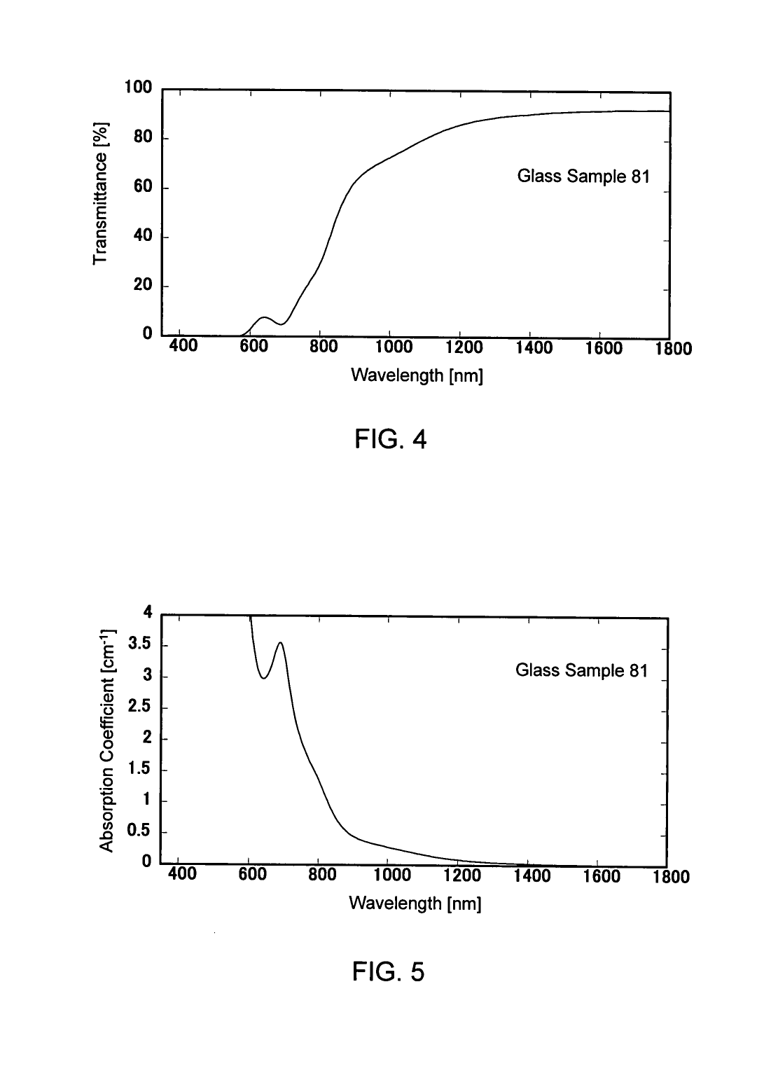

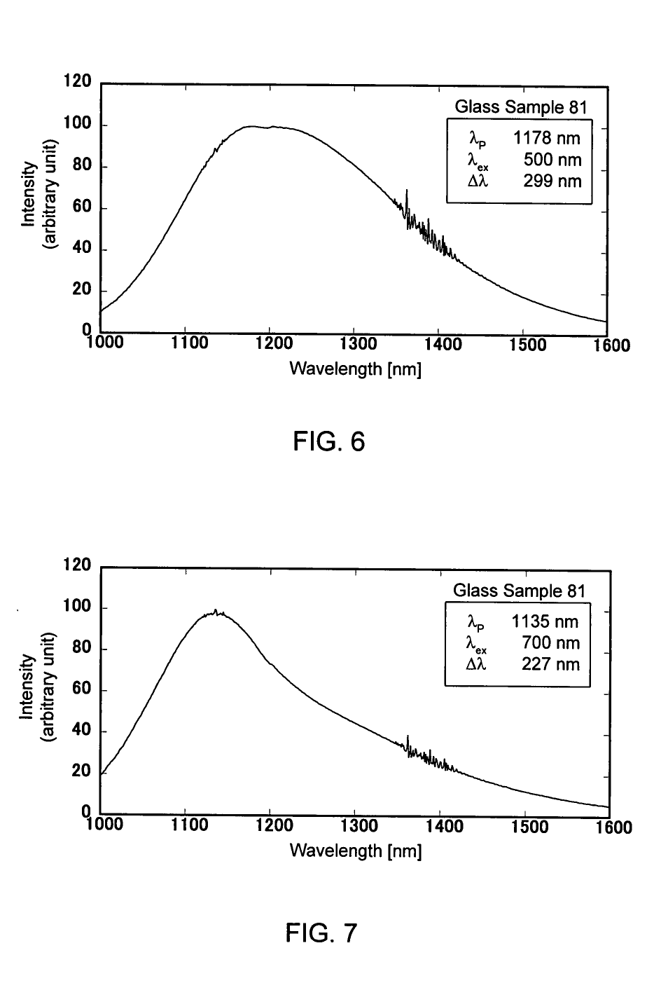

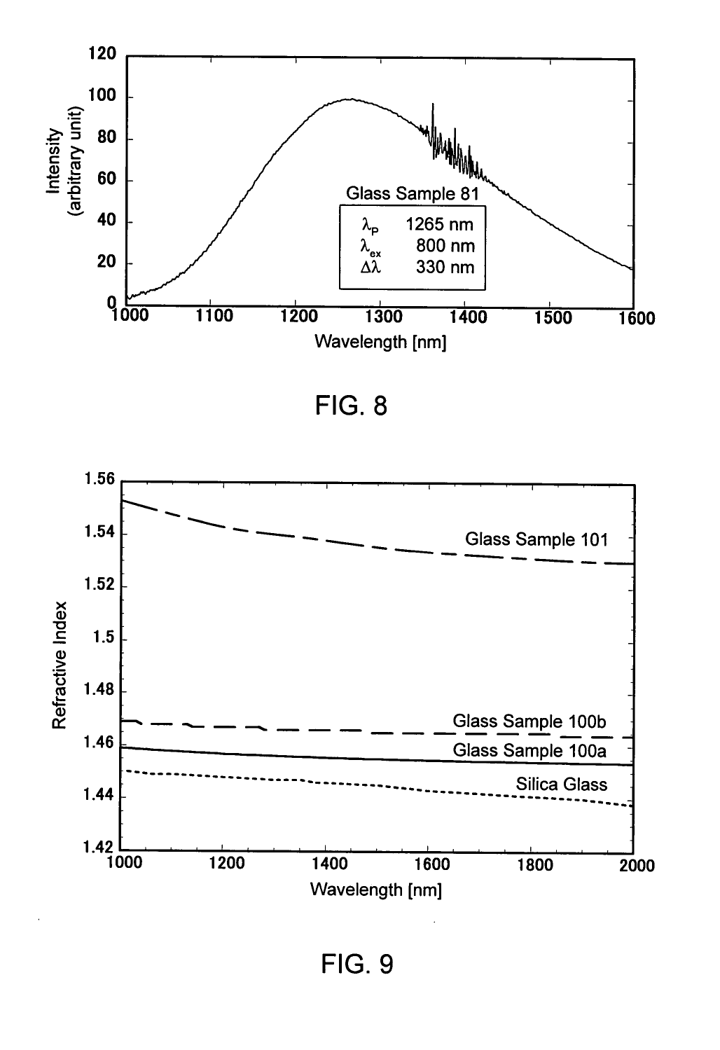

As shown in Table 4, the glass sample 81 showed almost the equivalent gain coefficient although having the bismuth oxide content of half that in the glass sample 80. FIGS. 4 to 8 show the transmission spectrum, the absorption coefficient spectrum and the fluorescence spectra by each excitation light having 500 nm, 700 nm and 800 nm in the glass sample 81.

### EXAMPLE 4

In the same manner as the Example 2, glass samples having three types of composition (glass sample 100a; 0.5Bi₂O₃-3.5Al₂O₃-96.0SiO₂, glass sample 100b; 1.0Bi₂O₃-7.0Al₂O₃-0.2Y₂O₃-91.8SiO₂, glass sample 101; 3.0Bi₂O₃-7.0Al₂O₃-0.2Y₂O₃-5.0Ge₂O3-84.8SiO₂) were obtained. Wavelength dependency of the refractive index in each glass sample was measured. FIG. 9 shows results of the measurement along with the wavelength dependency of the refractive index of silica glass (100SiO₂) (using the value written in a brochure of Sigma Koki Co., Ltd.).

As shown in FIG. 9, the glass sample 101, in which GeO₂ is added, has a higher refractive index in the wavelength range from 1000 nm to 2000 nm compared to the indexes of the glass samples 100a and 100b, in which GeO₂ is not added, and to silica glass, and the values were in a range from 1.52 to 1.56. Glasses having a sufficiently high refractive index, such as the glass sample 101, are suitable to make a core for an optical fiber having a clad of silica-based glass.

### INDUSTRIAL APPLICABILITY

The present invention is to provide a glass composition that can function as a light emitter or an optical amplification medium in the infrared wavelength range and thus has a great value for application in technical fields such as optical communication.

1. A glass composition comprising bismuth oxide, Al₂O₃ and SiO₂, the bismuth oxide including bismuth functioning as a luminous species, the glass composition emitting fluorescence in the infrared wavelength range upon irradiation of excitation light,
wherein SiO₂ is a main component of glass network forming oxide included in the glass composition,
the glass composition further comprises at least one oxide selected from TiO₂, GeO₂, P₂O₅ and B₂O₃,
the at least one oxide includes TiO₂ and GeO₂,
a total content of SiO₂, the at least one oxide, Y₂0₃ and lanthanide oxide, Y₂O₃ and the lanthanide oxide being optional components, is over 80 mol %,
a total content of TiO₂ and GeO₂ is 1 mol % or more and is more than a total content of monovalent metal oxide and divalent metal oxide, the monovalent metal oxide and the divalent metal oxide being optional components, and
the total content of monovalent metal oxide and divalent metal oxide is below 5 mol %.

2. (canceled)

3. The glass composition according to claim 1, wherein a content of TiO₂ is below 10 mol %.

4. (canceled)

5. The glass composition according to claim 1, further comprising at least one selected from Y₂O₃, La₂O₃ and Lu₂O₃.

6. The glass composition according to claim 5, wherein a total content of Y₂O₃, La₂O₃ and Lu₂O₃ is from 0.1 mol % to 5 mol %.

7. The glass composition according to claim 1, wherein a content of the glass network forming oxide is over 80 mol %.

8. The glass composition according to claim 7, wherein a content of SiO₂ is 75 mol % or more.

9. (canceled)

10. (canceled)

11. (canceled)

12. The glass composition according to claim 1, wherein a content of bismuth oxide in terms of Bi₂O₃ is in a range from 0.01 mol % to 15 mol %.

13. The glass composition according to claim 12,
wherein the content of bismuth oxide in terms of Bi₂O₃ is in a range from 0.01 mol % to 0.5 mol %.

14. (canceled)

15. The glass composition according to claim 1, further comprising the following optional components along with the bismuth oxide, Al₂O₃, SiO₂ TiO₂ and GeO₂, indicated by mol %:
Li₂O 0 or more and below 5;
Na₂O from 0 to below 5;
K₂O from 0 to below 5;
MgO 0 or more and below 5;
CaO 0 or more and below 5;
SrO from 0 to below 5;
BaO from 0 to below 5;
ZnO from 0 to below 5;
P₂O₅ from 0 to 10;
B₂O₃ from 0 to 10;
ZrO₂ from 0 to 5;
Y₂O₃ from 0 to 5; and
lanthanide oxide from 0 to 5.

16. An optical fiber comprising the glass composition according to claim 1.

17. An optical amplification apparatus comprising the glass composition according to claim 1.

18. A method of amplifying signal light, comprising introducing excitation light and signal light, so as to amplify the signal light, into the glass composition according to claim 1.

19. The glass composition according to claim 1, wherein a fluorescence intensity at a wavelength of 1250 nm from the glass composition upon irradiation of excitation light having a wavelength of 800 nm is higher than the fluorescence intensity from a reference glass composition having SiO₂, instead of TiO₂ and GeO₂, added in an amount of TiO₂ and GeO₂ in the glass composition.

20. A glass composition comprising bismuth oxide, Al₂O₃ and SiO₂, the bismuth oxide including bismuth functioning as a luminous species, the glass composition emitting fluorescence in the infrared wavelength range upon irradiation of excitation light,
wherein SiO₂ is a main component of glass network forming oxide included in the glass composition,
the glass composition further comprises at least one oxide selected from TiO₂, GeO₂, P₂O₅ and B₂O₃,
the at least one oxide includes GeO₂,
a total content of SiO₂, the at least one oxide, Y₂O₃ and lanthanide oxide, Y₂O₃ and the lanthanide oxide being optional components, is over 80 mol %
a content of GeO₂ is 1 mol % or more and is more than a total content of monovalent metal oxide and divalent metal oxide, the monovalent metal oxide and the divalent metal oxide being optional components,
the total content of monovalent metal oxide and divalent metal oxide is below 5 mol %, and
a content of bismuth oxide in terms of Bi₂O₃ is from 0.01 mol % to 0.1 mol %.

21. The glass composition according to claim 20, wherein the glass composition is free from TiO₂.

22. The glass composition according to claim 20, further comprising at least one selected from Y₂O₃, La₂O₃ and Lu₂O₃.

23. The glass composition according to claim 20, wherein a total content of Y₂O₃, La₂O₃ and Lu₂O₃ is from 0.1 mol % to 5 mol %.

24. The glass composition according to claim 20, wherein a fluorescence intensity at a wavelength of 1250 nm from the glass composition upon irradiation of excitation light having a wavelength of 800 nm is higher than the fluorescence intensity from a reference glass composition having TiO₂ added in an amount of GeO₂ in the glass composition and having SiO₂ reduced in the amount of TiO₂.

25. A glass composition, consisting essentially of bismuth oxide, Al₂O₃, Y₂O₃, TiO₂, GeO₂ and SiO₂,
wherein SiO₂ is a main component of glass network forming oxide,
bismuth included in the bismuth oxide functions as a luminous species, and
the glass composition emits fluorescence in the infrared wavelength range upon irradiation of excitation light.

26. The glass composition according to claim 25, wherein a content of bismuth oxide in terms of Bi₂O₃ is from 0.01 mol % to 1 mol %, a content of Al₂O₃ is from 0.5 mol % to 25 mol %, a content of Y₂O₃ is from 0.1 mol % to 5 mol %, a total content of GeO₂ and TiO₂ is 0.1 mol % or more, where the content of GeO₂ is 20 mol % or less and the content of TiO₂ is below 10 mol %, and SiO₂ represents the rest.

27. A glass composition, consisting essentially of bismuth oxide, Al₂O₃, Y₂O₃, GeO₂ and SiO₂,
wherein SiO₂ is a main component of glass network forming oxide,
bismuth included in the bismuth oxide functions as a luminous species, and
the glass composition emits fluorescence in the infrared wavelength range upon irradiation of excitation light.

28. The glass composition according to claim 27, wherein a content of bismuth oxide in terms of Bi₂O₃ is from 0.01 mol % to 1 mol %, a content of Al₂O₃ is from 0.5 mol % to 25 mol %, a content of Y₂O₃ is from 0.1 mol % to 5 mol %, a content of GeO₂ is 0.1 mol % to 20 mol %, and SiO₂ represents the rest.

29. An optical fiber comprising the glass composition according to claim 20.

30. An optical amplification apparatus comprising the glass composition according to claim 20.

31. A method of amplifying signal light, comprising introducing excitation light and signal light, so as to amplify the signal light, into the glass composition according to claim 20.

32. An optical fiber comprising the glass composition according to claim 25.

33. An optical fiber comprising the glass composition according to claim 27.

34. An optical amplification apparatus comprising the glass composition according to claim 25.

35. An optical amplification apparatus comprising the glass composition according to claim 27.

36. A method of amplifying signal light, comprising introducing excitation light and signal light, so as to amplify the signal light, into the glass composition according to claim 25.

37. A method of amplifying signal light, comprising introducing excitation light and signal light, so as to amplify the signal light, into the glass composition according to claim 27.
